(19) United States
(12) Patent Application Publication
(10) Pub. No.: US 2026/0154886 A1
(43) Pub. Date: Jun. 4, 2026

(54) SYSTEMS AND METHODS FOR IMAGE RECONSTRUCTION

(71) Applicant: SHANGHAI UNITED IMAGING HEALTHCARE CO., LTD., Shanghai (CN)

(72) Inventor: Haohua SUN, Shanghai (CN)

(73) Assignee: SHANGHAI UNITED IMAGING HEALTHCARE CO., LTD., Shanghai (CN)

(21) Appl. No.: 19/455,745

(22) Filed: Jan. 21, 2026

Related U.S. Application Data
(63) Continuation of application No. PCT/CN2023/112926, filed on Aug. 14, 2023.

(51) Int. Cl. G06T 12/20; G06T 12/10

(52) U.S. Cl. CPC G06T 12/20; G06T 12/10; G06T 2210/41

(57) ABSTRACT

The present disclosure relates to systems and methods for image reconstruction. The method may include obtaining original raw data acquired by a medical device, obtaining an initial image, and generating a target image based on the original raw data and the initial image according to an image reconstruction algorithm.

### CROSS-REFERENCE TO RELATED APPLICATIONS

This application is a Continuation of International Application No. PCT/CN2023/112926, filed on Aug. 14, 2023, the contents of which are hereby incorporated by reference.

### TECHNICAL FIELD

This disclosure generally relates to systems and methods for medical imaging, and more particularly, relates to systems and methods for image reconstruction.

### BACKGROUND

Medical imaging, such as computed tomography (CT) is widely used in disease diagnosis and/or treatment for various medical conditions (e.g., tumors, coronary heart diseases, brain diseases). Image reconstruction is a key technology used in the field of medical imaging. Raw data collected by a medical device (e.g., a CT device) may be processed using an image reconstruction algorithm to generate a reconstructed image. However, an image reconstruction process (e.g., an iterative reconstruction process) is generally computationally intensive and time consuming. Therefore, it is desirable to provide systems and methods for image reconstruction with improved reconstruction speed, thereby improving the efficiency of medical analysis and/or diagnosis.

### SUMMARY

According to an aspect of the present disclosure, a method for image reconstruction, which is implemented on a computing device including at least one processor and at least one storage device is provided. The method may include obtaining original raw data acquired by a medical device, obtaining an initial image, and generating a target image based on the original raw data and the initial image according to an image reconstruction algorithm. The generating a target image based on the original raw data and the initial image according to an image reconstruction algorithm may include determining a processed initial image by transforming the initial image from an initial coordinate system to a target coordinate system and generating the target image based on the second difference image. A plurality of element values in the processed initial image may be represented by a plurality of grids in the target coordinate system and the target coordinate system may be determined based on a structure of a detector of the medical device.

In some embodiments, the generating the target image based on the processed initial image may include determining a first difference image based on the processed initial image, determining a second difference image by transforming the first difference image from the target coordinate system to the initial coordinate system, and generating the target image based on the second difference image. The plurality of element values in the second difference image may be represented by a plurality of grids in the initial coordinate system.

In some embodiments, the determining a first difference image based on the processed initial image may include determining first projection data by performing a forward projection operation on the processed initial image, determining second projection data based on the first projection data and the original raw data, and determining the first difference image by performing a back projection operation on the second projection data.

In some embodiments, the original raw data may correspond to a plurality of initial projection angles. The determining a processed initial image by transforming the initial image from an initial coordinate system to a target coordinate system may comprise determining a second processed initial image by transforming the initial image from the initial coordinate system to a reference coordinate system and determining the processed initial image by transforming the second processed initial image from the reference coordinate system to the target coordinate system. The reference coordinate system may correspond to a reference projection angle.

In some embodiments, the determining a second difference image by transforming the first difference image from the target coordinate system to the initial coordinate system may comprise determining a third difference image by transforming the first difference image from the target coordinate system to the reference coordinate system, and determining the second difference image by transforming the third difference image from the reference coordinate system to the initial coordinate system.

In some embodiments, an origin of the reference coordinate system may be located at a rotation center of a gantry of the medical device, and a first axis direction of the reference coordinate system may be the same as a first axis direction of the target coordinate system.

In some embodiments, the target coordinate system may at least include a polar coordinate system.

In some embodiments, the detector of the medical device may include a plurality of detector units including at least one row of detector units arranged along a first direction and at least one column of detector units arranged along a second direction. An origin of the target coordinate system may be located at a focal spot of a tube of the medical device. A first axis direction of the target coordinate system may be along a line connecting the origin and a detector unit of the plurality of detector units. A second axis direction of the target coordinate system may be an angle direction between a line connecting the origin and a detector unit of the at least one row of detector units and the first axis direction. A third axis direction of the target coordinate system may be an angle direction between a line connecting a detector unit of the plurality of detector units and the origin, and a plane formed by the first axis direction and the second axis direction.

In some embodiments, a size of each grid of the plurality of grids in the target coordinate system may be related to a size of each detector unit of the plurality of detector units.

In some embodiments, a width of the each grid of the plurality of grids along the second axis direction of the target coordinate system may be related to a width of a corresponding detector unit along the first direction. A height of the each grid of the plurality of grids along the third axis direction of the target coordinate system may be related to a height of the corresponding detector unit along the second direction.

In some embodiments, a length of the each grid of the plurality of grids along the first axis direction of the target coordinate system may be substantially the same as the width of the each grid of the plurality of grids along the second axis direction of the target coordinate system.

In some embodiments, the farther a grid is from the origin of the target coordinate system along the first axis direction, the smaller an angle between two sides of the grid along the second axis direction, or the smaller an angle between two sides of the grid along the third axis direction.

In some embodiments, a width of a detector unit along the first direction may be an integer multiple of a width of a corresponding grid along the second axis direction of the target coordinate system, or a height of a detector unit along the second direction may be an integer multiple of a height of a corresponding grid along the third axis direction of the target coordinate system.

In some embodiments, a projected edge of the plurality of grids on a detector plane may be coincident with or parallel to an edge of the detector.

In some embodiments, the determining a second processed initial image by transforming the initial image from the initial coordinate system to a reference coordinate system may comprise obtaining a plurality of element values of a plurality of elements at a plurality of grids in the reference coordinate system by performing an interpolation operation on a plurality of element values of a plurality of elements at a plurality of grids in the initial coordinate system, and determining the second processed initial image based on the plurality of element values of the plurality of elements at the plurality of grids in the reference coordinate system.

In some embodiments, the determining the processed initial image by transforming the second processed initial image from the reference coordinate system to the target coordinate system may comprise obtaining a plurality of element values of a plurality of elements at a plurality of non-integer grids in the reference coordinate system by performing an interpolation operation on a plurality of element values of a plurality of elements at a plurality of integer grids in the reference coordinate system. The plurality of non-integer grids in the reference coordinate system may correspond to a plurality of integer grids in the target coordinate system. The determining the processed initial image by transforming the second processed initial image from the reference coordinate system to the target coordinate system may also comprise obtaining a plurality of element values of a plurality of elements at the plurality of integer grids in the target coordinate system based on the plurality of element values of the plurality of elements at the plurality of non-integer grids in the reference coordinate system, and determining the processed initial image based on the plurality of element values of the plurality of elements at the plurality of integer grids in the target coordinate system.

In some embodiments, for each integer grid of a plurality of integer grids in the reference coordinate system, the determining a third difference image by transforming the first difference image from the target coordinate system to the reference coordinate system may comprise determining a plurality of corresponding non-integer grids in the reference coordinate system. The plurality of corresponding non-integer grids in the reference coordinate system may correspond to a plurality of integer grids in the target coordinate system. The determining a third difference image by transforming the first difference image from the target coordinate system to the reference coordinate system may also comprise determining a plurality of element values of a plurality of elements at the plurality of corresponding non-integer grids in the reference coordinate system based on a plurality of element values of a plurality of elements at the plurality of integer grids in the target coordinate system, and determining an element value of the integer grid in the reference coordinate system by performing an interpolation operation on the plurality of element values of the plurality of elements at the plurality of corresponding non-integer grids in the reference coordinate system. The determining a third difference image by transforming the first difference image from the target coordinate system to the reference coordinate system may further comprise determining the third difference image based on a plurality of element values of a plurality of elements at the plurality of integer grids in the reference coordinate system.

In some embodiments, the determining the second difference image by transforming the third difference image from the reference coordinate system to the initial coordinate system may comprise obtaining a plurality of element values of a plurality of elements at the plurality of grids in the initial coordinate system by performing an interpolation operation on a plurality of element values of a plurality of elements at a plurality of grids in the reference coordinate system, and determining the second difference image based on the plurality of element values of the plurality of elements at the plurality of grids in the initial coordinate system.

In some embodiments, the image reconstruction algorithm may include an iterative reconstruction algorithm.

According to another aspect of the present disclosure, a system for image reconstruction is provided. The system may include at least one storage device including a set of instructions and at least one processor configured to communicate with the at least one storage device. When executing the set of instructions, the at least one processor may be configured to direct the system to perform operations including obtaining original raw data acquired by a medical device, obtaining an initial image, and generating a target image based on the original raw data and the initial image according to an image reconstruction algorithm. The generating a target image based on the original raw data and the initial image according to an image reconstruction algorithm may include determining a processed initial image by transforming the initial image from an initial coordinate system to a target coordinate system and generating the target image based on the second difference image. A plurality of element values in the processed initial image may be represented by a plurality of grids in the target coordinate system and the target coordinate system may be determined based on a structure of a detector of the medical device.

According to yet another aspect of the present disclosure, a non-transitory computer readable medium including a set of instructions for generating a 3D image is provided. When executed by at least one processor, the set of instructions may direct the at least one processor to effectuate a method, the method may include obtaining original raw data acquired by a medical device, obtaining an initial image, and generating a target image based on the original raw data and the initial image according to an image reconstruction algorithm. The generating a target image based on the original raw data and the initial image according to an image reconstruction algorithm may include determining a processed initial image by transforming the initial image from an initial coordinate system to a target coordinate system and generating the target image based on the second difference image. A plurality of element values in the processed initial image may be represented by a plurality of grids in the target coordinate system and the target coordinate system may be determined based on a structure of a detector of the medical device.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments.

These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary medical system according to some embodiments of the present disclosure;

FIG. 2 is a schematic diagram illustrating exemplary hardware and/or software components of an exemplary computing device on which a processing device may be implemented according to some embodiments of the present disclosure;

FIG. 3 is a schematic diagram illustrating exemplary hardware and/or software components of an exemplary mobile device according to some embodiments of the present disclosure;

FIG. 4 is a schematic diagram illustrating an exemplary processing device according to some embodiments of the present disclosure;

FIG. 5 is a flowchart illustrating an exemplary process for generating a target image according to some embodiments of the present disclosure;

FIG. 6 is a flowchart illustrating an exemplary process for generating a target image according to some embodiments of the present disclosure;

FIG. 7 is a flowchart illustrating an exemplary process for determining a processed initial image according to one or more historical record modes according to some embodiments of the present disclosure;

FIG. 8 is a flowchart illustrating an exemplary process for determining a second difference image according to one or more historical record modes according to some embodiments of the present disclosure;

FIG. 9 is a schematic diagram illustrating an exemplary polar coordinate system according to some embodiments of the present disclosure;

FIG. 10 is a schematic diagram illustrating exemplary grids in a polar coordinate system according to some embodiments of the present disclosure;

FIG. 11 is a schematic diagram illustrating an exemplary reference Cartesian coordinate system and an exemplary polar coordinate system according to some embodiments of the present disclosure; and

FIG. 12 is a schematic diagram illustrating an exemplary reference Cartesian coordinate system and an exemplary initial Cartesian coordinate system according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Also, the term “exemplary” is intended to refer to an example or illustration.

It will be understood that the terms “system,” “engine,” “unit,” “module,” and/or “block” used herein are one method to distinguish different components, elements, parts, sections or assembly of different levels in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

Spatial and functional relationships between elements are described using various terms, including “connected,” “attached,” and “mounted.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, attached, or positioned to another element, there are no intervening elements present. Other words used to describe the relationship between elements should be interpreted in a like fashion (e.g., “between,” versus “directly between,” “adjacent,” versus “directly adjacent,” etc.).

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The term “image” in the present disclosure is used to collectively refer to image data (e.g., scan data, projection data) and/or images of various forms, including a two-dimensional (2D) image, a three-dimensional (3D) image, a four-dimensional (4D), etc. The term “anatomical structure” in the present disclosure may refer to gas (e.g., air), liquid (e.g., water), solid (e.g., stone), cell, tissue, organ of a subject, or any combination thereof, which may be displayed in an image and really exist in or on the subject's body. The term “region,” “location,” and “area” in the present disclosure may refer to a location of an anatomical structure shown in the image or an actual location of the anatomical structure existing in or on the subject's body, since the image may indicate the actual location of a certain anatomical structure existing in or on the subject's body. The term “an image of a subject” may be referred to as the subject for brevity.

An aspect of the present disclosure relates to a system and method for image reconstruction. According to some embodiments of the present disclosure, a processing device may obtain original raw data acquired by a medical device. The processing device may obtain an initial image. The processing device may generate a target image based on the original raw data and the initial image according to an image reconstruction algorithm. For example, the processing device may determine a processed initial image by transforming the initial image from an initial Cartesian coordinate system to a polar coordinate system. A plurality of element values in the processed initial image may be represented by a plurality of integer grids in the polar coordinate system. The processing device may determine first projection data by performing a forward projection operation on the processed initial image. The processing device may determine second projection data based on the first projection data and the original raw data. The processing device may determine a first difference image by performing a back projection operation on the second projection data. The processing device may determine a second difference image by transforming the first difference image from the polar coordinate system to the initial Cartesian coordinate system. A plurality of element values in the second difference image may be represented by a plurality of integer grids in the initial Cartesian coordinate system. The processing device may generate the target image based on the second difference image.

In some embodiments, the polar coordinate system may be established based on a structure of a detector of the medical device. For example, the polar coordinate system may include a plurality of grids. A size of each grid of the plurality of grids may be related to a size of each detector unit of a plurality of detector units of the detector of the medical device. Accordingly, by transforming an image (e.g., the initial image) from an initial Cartesian coordinate system to the polar coordinate system, a plurality of elements of a transformed image (e.g., the processed initial image) may be discretized according to the structure of the detector of the medical device. A projected edge of the plurality of elements of the transformed image on a detector plane may be coincident with or parallel to an edge of the detector. When the forward projection operation is performed on the transformed image (e.g., the processed initial image), a summation operation may be performed on an integer number of elements, which may reduce computation complexity, improve the computing speed of the forward projection operation, and accordingly improve the efficiency of image reconstruction.

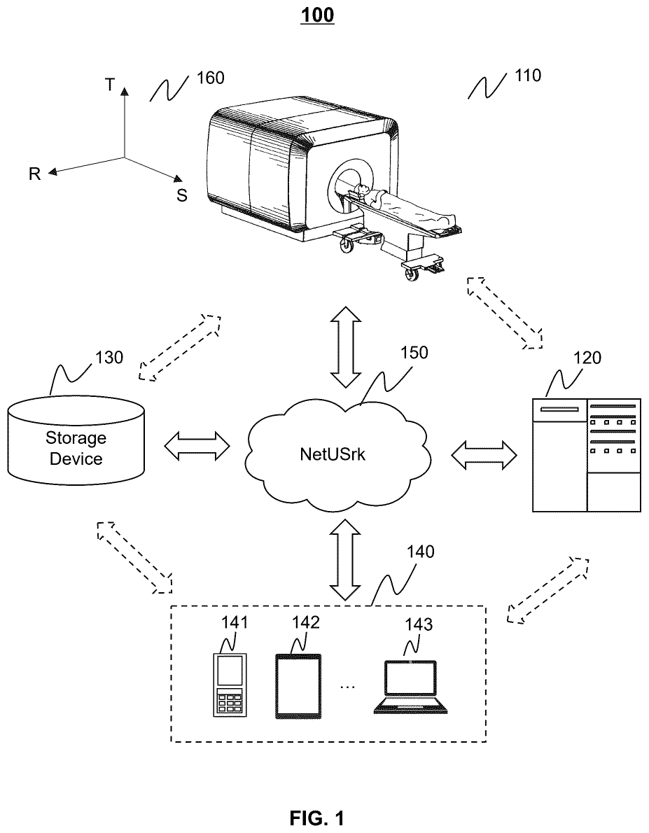

FIG. 1 is a schematic diagram illustrating an exemplary medical system according to some embodiments of the present disclosure. As illustrated, a medical system 100 may include a medical device 110, a processing device 120, a storage device 130, a terminal 140, and a network 150. The components of the medical system 100 may be connected in one or more of various ways. Merely by way of example, as illustrated in FIG. 1, the medical device 110 may be connected to the processing device 120 directly as indicated by the bi-directional arrow in dotted lines linking the medical device 110 and the processing device 120, or through the network 150. As another example, the storage device 130 may be connected to the medical device 110 directly as indicated by the bi-directional arrow in dotted lines linking the medical device 110 and the storage device 130, or through the network 150. As still another example, the terminal 140 may be connected to the processing device 120 directly as indicated by the bi-directional arrow in dotted lines linking the terminal 140 and the processing device 120, or through the network 150.

The medical device 110 may be configured to acquire imaging data relating to a subject. The imaging data relating to a subject may include an image (e.g., an image slice), projection data, or a combination thereof. In some embodiments, the imaging data may be a two-dimensional (2D) imaging data, a three-dimensional (3D) imaging data, a four-dimensional (4D) imaging data, or the like, or any combination thereof. The subject may be biological or non-biological. For example, the subject may include a patient, a man-made object, etc. As another example, the subject may include a specific portion, an organ, and/or tissue of the patient. Specifically, the subject may include the head, the neck, the thorax, the heart, the stomach, a blood vessel, soft tissue, a tumor, or the like, or any combination thereof. In the present disclosure, “object” and “subject” are used interchangeably.

In some embodiments, the medical device 110 may include a single modality imaging device. For example, the medical device 110 may include a positron emission tomography (PET) device, a single-photon emission computed tomography (SPECT) device, a magnetic resonance imaging (MRI) device (also referred to as an MR device, an MR scanner), a computed tomography (CT) device, an ultrasound (US) device, an X-ray imaging device, or the like, or any combination thereof. In some embodiments, the medical device 110 may include a multi-modality imaging device. Exemplary multi-modality imaging devices may include a PET-CT device, a PET-MRI device, a SPET-CT device, or the like, or any combination thereof. The multi-modality imaging device may perform multi-modality imaging simultaneously. For example, the PET-CT device may generate structural X-ray CT data and functional PET data simultaneously in a single scan. The PET-MRI device may generate MRI data and PET data simultaneously in a single scan.

The processing device 120 may process data and/or information obtained from the medical device 110, the storage device 130, and/or the terminal(s) 140. For example, the processing device 120 may obtain original raw data acquired by a medical device (e.g., the medical device 110). As another example, the processing device 120 may obtain an initial image. As another example, the processing device 120 may generate a target image based on original raw data and an initial image according to an image reconstruction algorithm. In some embodiments, the processing device 120 may be a single server or a server group. The server group may be centralized or distributed. In some embodiments, the processing device 120 may be local or remote. For example, the processing device 120 may access information and/or data from the medical device 110, the storage device 130, and/or the terminal(s) 140 via the network 150. As another example, the processing device 120 may be directly connected to the medical device 110, the terminal(s) 140, and/or the storage device 130 to access information and/or data. In some embodiments, the processing device 120 may be implemented on a cloud platform. For example, the cloud platform may include a private cloud, a public cloud, a hybrid cloud, a community cloud, a distributed cloud, an inter-cloud, a multi-cloud, or the like, or a combination thereof. In some embodiments, the processing device 120 may be part of the terminal 140. In some embodiments, the processing device 120 may be part of the medical device 110.

The storage device 130 may store data, instructions, and/or any other information. In some embodiments, the storage device 130 may store data obtained from the medical device 110, the processing device 120, and/or the terminal(s) 140. The data may include image data acquired by the processing device 120, algorithms and/or models for processing the image data, etc. For example, the storage device 130 may store original raw data of a subject acquired by a medical device. As another example, the storage device 130 may store an initial image determined by the processing device 120. As another example, the storage device 130 may store a target image determined by the processing device 120. As another example, the storage device 130 may store a polar coordinate system and/or a reference Cartesian coordinate system determined by the processing device 120. In some embodiments, the storage device 130 may store data and/or instructions that the processing device 120 and/or the terminal 140 may execute or use to perform exemplary methods described in the present disclosure. In some embodiments, the storage device 130 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memories may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), a high-speed RAM, etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more other components in the medical system 100 (e.g., the processing device 120, the terminal(s) 140). One or more components in the medical system 100 may access the data or instructions stored in the storage device 130 via the network 150. In some embodiments, the storage device 130 may be integrated into the medical device 110.

The terminal(s) 140 may be connected to and/or communicate with the medical device 110, the processing device 120, and/or the storage device 130. In some embodiments, the terminal 140 may include a mobile device 141, a tablet computer 142, a laptop computer 143, or the like, or any combination thereof. For example, the mobile device 141 may include a mobile phone, a personal digital assistant (PDA), a gaming device, a navigation device, a point of sale (POS) device, a laptop, a tablet computer, a desktop, or the like, or any combination thereof. In some embodiments, the terminal 140 may include an input device, an output device, etc. The input device may include alphanumeric and other keys that may be input via a keyboard, a touchscreen (for example, with haptics or tactile feedback), a speech input, an eye tracking input, a brain monitoring system, or any other comparable input mechanism. Other types of the input device may include a cursor control device, such as a mouse, a trackball, or cursor direction keys, etc. The output device may include a display, a printer, or the like, or any combination thereof.

The network 150 may include any suitable network that can facilitate the exchange of information and/or data for the medical system 100. In some embodiments, one or more components of the medical system 100 (e.g., the medical device 110, the processing device 120, the storage device 130, the terminal(s) 140, etc.) may communicate information and/or data with one or more other components of the medical system 100 via the network 150. For example, the processing device 120 and/or the terminal 140 may obtain original raw data of a subject from the medical device 110 via the network 150. As another example, the processing device 120 and/or the terminal 140 may obtain information stored in the storage device 130 via the network 150. The network 150 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (VPN), a satellite network, a telephone network, routers, hubs, witches, server computers, and/or any combination thereof. For example, the network 150 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 150 may include one or more network access points. For example, the network 150 may include wired and/or wireless network access points such as base stations and/or internet exchange points through which one or more components of the medical system 100 may be connected to the network 150 to exchange data and/or information.

In some embodiments, a medical coordinate system 160 may be provided for the medical system 100 to define a position of a component (e.g., an absolute position, a position relative to another component) and/or a movement of the component. For illustration purposes, the medical coordinate system 160 may include the R-axis, the T-axis, and the S-axis. The R-axis and the S-axis shown in FIG. 1 may be horizontal, and the T-axis may be vertical. As illustrated, a positive R direction along the R-axis may be from the right side to the left side of a scanning table viewed from the direction facing the front of the medical device 110; a positive T direction along the T-axis may be from the lower part (or from the floor where the medical device 110 stands) to the upper part of a gantry of the medical device 110; and a positive S direction along the S-axis may be the direction in which the scanning table is moved out of a scanning channel (or referred to as a bore) of the medical device 110 viewed from the direction facing the front of the medical device 110.

This description is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. However, those variations and modifications do not depart the scope of the present disclosure.

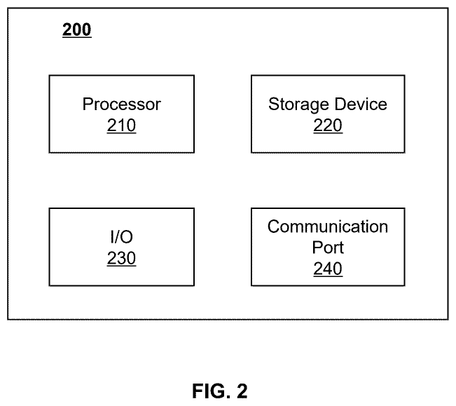

FIG. 2 is a schematic diagram illustrating exemplary hardware and/or software components of an exemplary computing device on which the processing device 120 may be implemented according to some embodiments of the present disclosure. As illustrated in FIG. 2, a computing device 200 may include a processor 210, a storage device 220, an input/output (I/O) 230, and a communication port 240.

The processor 210 may execute computer instructions (e.g., program code) and perform functions of the processing device 120 in accordance with techniques described herein. The computer instructions may include, for example, routines, programs, objects, components, data structures, procedures, modules, and functions, which perform particular functions described herein. For example, the processor 210 may process image data obtained from the medical device 110, the terminal device 140, the storage device 130, and/or any other component of the medical system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combination thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both process A and process B, it should be understood that process A and process B may also be performed by two or more different processors jointly or separately in the computing device 200 (e.g., a first processor executes process A and a second processor executes process B, or the first and second processors jointly execute processes A and B).

The storage device 220 may store data/information obtained from the medical device 110, the terminal device 140, the storage device 130, and/or any other component of the medical system 100. The storage device 220 may be similar to the storage device 130 described in connection with FIG. 1, and the detailed descriptions are not repeated here.

The I/O 230 may input and/or output signals, data, information, etc. In some embodiments, the I/O 230 may enable a user interaction with the processing device 120. In some embodiments, the I/O 230 may include an input device and an output device. Examples of the input device may include a keyboard, a mouse, a touchscreen, a microphone, a sound recording device, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touchscreen, or the like, or a combination thereof.

The communication port 240 may be connected to a network (e.g., the network 150) to facilitate data communications. The communication port 240 may establish connections between the processing device 120 and the medical device 110, the terminal device 140, and/or the storage device 130. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. In some embodiments, the communication port 240 may be and/or include a standardized communication port, such as RS232, RS485. In some embodiments, the communication port 240 may be a specially designed communication port. For example, the communication port 240 may be designed in accordance with the digital imaging and communications in medicine (DICOM) protocol.

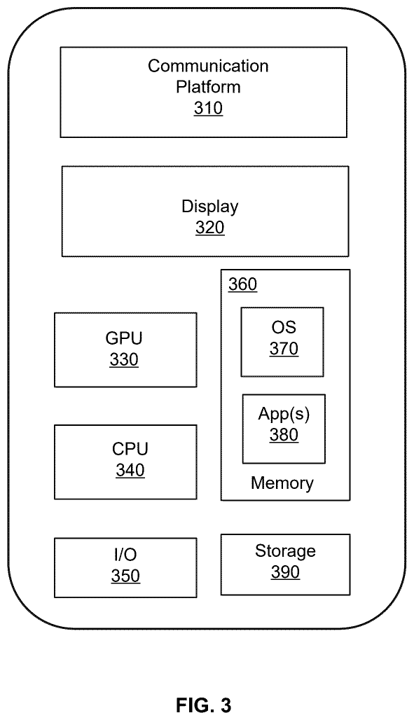

FIG. 3 is a schematic diagram illustrating exemplary hardware and/or software components of an exemplary mobile device according to some embodiments of the present disclosure. In some embodiments, the terminal device 140 and/or the processing device 120 may be implemented on a mobile device 300, respectively.

As illustrated in FIG. 3, the mobile device 300 may include a communication platform 310, a display 320, a graphics processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300.

In some embodiments, the communication platform 310 may be configured to establish a connection between the mobile device 300 and other components of the medical system 100, and enable data and/or signal to be transmitted between the mobile device 300 and other components of the medical system 100. For example, the communication platform 310 may establish a wireless connection between the mobile device 300 and the medical device 110, and/or the processing device 120. The wireless connection may include, for example, a Bluetooth™ link, a Wi-Fi™ link, a WiMax™ link, a WLAN link, a ZigBee link, a mobile network link (e.g., 3G, 4G, 5G), or the like, or any combination thereof. The communication platform 310 may also enable the data and/or signal between the mobile device 300 and other components of the medical system 100. For example, the communication platform 310 may transmit data and/or signals inputted by a user to other components of the medical system 100. The inputted data and/or signals may include a user instruction. As another example, the communication platform 310 may receive data and/or signals transmitted from the processing device 120. The received data and/or signals may include imaging data acquired by the medical device 110.

In some embodiments, a mobile operating system (OS) 370 (e.g., iOS™, Android™, Windows Phone™, etc.) and one or more applications (App(s)) 380 may be loaded into the memory 360 from the storage 390 in order to be executed by the CPU 340. The applications 380 may include a browser or any other suitable mobile apps for receiving and rendering information from the processing device 120. User interactions with the information stream may be achieved via the I/O 350 and provided to the processing device 120 and/or other components of the medical system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result the drawings should be self-explanatory.

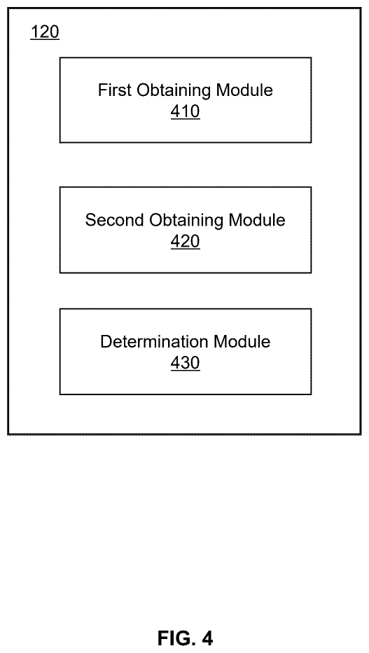

FIG. 4 is a schematic diagram illustrating an exemplary processing device according to some embodiments of the present disclosure. In some embodiments, the processing device 120 may include a first obtaining module 410, a second obtaining module 420, and a determination module 430.

The first obtaining module 410 may be configured to obtain original raw data acquired by a medical device. More descriptions of obtaining the initial vascular image may be found elsewhere in the present disclosure (e.g., operation 510 or the descriptions thereof).

The second obtaining module 420 may be configured to obtain an initial image. More descriptions of obtaining an initial image may be found elsewhere in the present disclosure (e.g., operation 520 or the descriptions thereof).

The determination module 430 may be configured to generate a target image based on the original raw data and the initial image according to an image reconstruction algorithm. More descriptions of generating a target image based on the original raw data and the initial image according to an image reconstruction algorithm may be found elsewhere in the present disclosure (e.g., operation 530 or descriptions thereof).

The modules in the processing device 120 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof.

It should be noted that the above description of the processing device 120 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more modules may be combined into a single module. For example, the first obtaining module 410 and the second obtaining module 420 may be combined into a single module. In some embodiments, one or more modules may be added or omitted in the processing device 120. For example, the processing device 120 may further include a storage module (not shown in FIG. 4) configured to store data and/or information (e.g., original raw data, an initial image, a target image, a reference Cartesian coordinate system, a polar coordinate system) associated with the medical system 100.

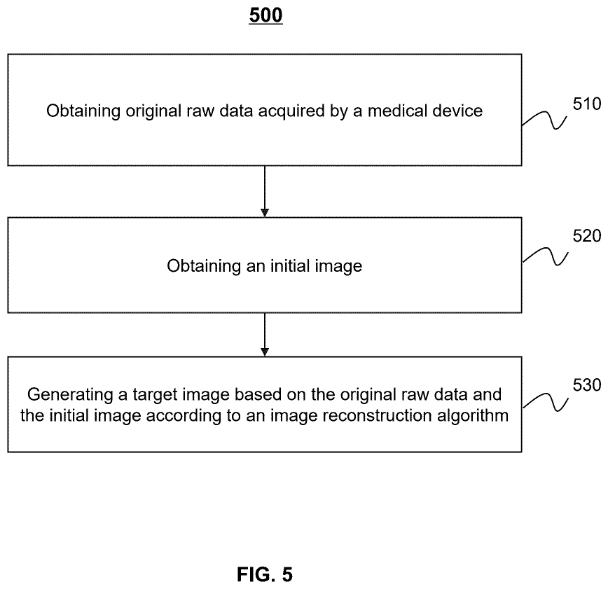

FIG. 5 is a flowchart illustrating an exemplary process for generating a target image according to some embodiments of the present disclosure. In some embodiments, process 500 may be executed by the medical system 100. For example, the process 500 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 500. The operations of the illustrated process presented below are intended to be illustrative. In some embodiments, the process 500 may be accomplished with one or more additional operations not described and/or without one or more of the operations discussed. Additionally, the order of the operations of process 500 illustrated in FIG. 5 and described below is not intended to be limiting.

In 510, the processing device 120 (e.g., the first obtaining module 410) may obtain original raw data acquired by a medical device.

In some embodiments, the original raw data may include original projection data obtained by scanning a subject using the medical device (e.g., the medical device 110). The original raw data (e.g., original CT projection data) may reflect attenuation information of radiation rays (e.g., X-rays) that pass through the subject. In some embodiments, the subject may include a biological subject and/or a non-biological subject. For example, the subject may include a specific portion of a body, such as the head, the thorax, the abdomen, or the like, or any combination thereof. As another example, the subject may be a man-made composition of organic and/or inorganic matters that are with or without life.

In some embodiments, the processing device 120 may obtain the original raw data from one or more projection angles by the medical device. For example, the medical device (e.g., a CT device) may perform a scan of the subject by irradiating the subject with X-rays. During the scan, a radiation source and a detector may rotate with a gantry around a scan axis (e.g., the S-axis of the coordinate system 160 as illustrated in FIG. 1) to scan the subject from different angles.

In some embodiments, the projection angle may refer to an angle formed by a line connecting the radiation source and a rotation center of the gantry and an axis in a coordinate system (e.g., the R-axis, the T-axis in the coordinate system 160 as illustrated in FIG. 1). In some embodiments, the radiation source may emit radiation rays (e.g., X-rays) toward the subject continuously when the gantry rotates. A plurality of sets of original raw data corresponding to a plurality of projection angles (e.g., a plurality of projection angles ranging from 0° to 360°) may be collected by the detector. Alternatively, the radiation source may emit radiation rays (e.g., X-rays) toward the subject intermittently when the gantry rotates.

In some embodiments, the processing device 120 may obtain the original raw data from one or more components (e.g., the medical device 110, the storage device 130, the terminal 140) of the medical system 100. Alternatively or additionally, the processing device 120 may obtain the original raw data from an external source (e.g., a medical database) via the network 150.

In 520, the processing device 120 (e.g., the second obtaining module 410) may obtain an initial image.

In some embodiments, the processing device 120 may determine the initial image based on the plurality of sets of original raw data corresponding to the plurality of projection angles collected by the detector.

In some embodiments, the initial image may include a plurality of elements (e.g., pixels, voxels) with estimated characteristics (e.g., a gray value, an intensity). In some embodiments, the gray values of the elements in the initial image may be set as different values or a same value. For example, the gray values of the elements in the initial image may be set as 0 or 1. In some embodiments, the initial image may be determined according to a default setting, manually set by a user (e.g., a doctor, a technician), or determined by the processing device 120 according to an actual need.

In 530, the processing device 120 (e.g., the determination module 430) may generate a target image based on the original raw data and the initial image according to an image reconstruction algorithm.

In some embodiments, the image reconstruction algorithm may include an iterative reconstruction algorithm. Exemplary iterative reconstruction algorithms may include an adaptive statistical iterative reconstruction (ASiR), a model based iterative reconstruction (MBiR), an iterative reconstruction in image space (iRIS), a sinogram affirmed iterative reconstruction (SAFIRE), a double model based iterative reconstruction (DMBIR), an adaptive iterative dose reduction (AIDR), IMR, or the like, or any combination thereof.

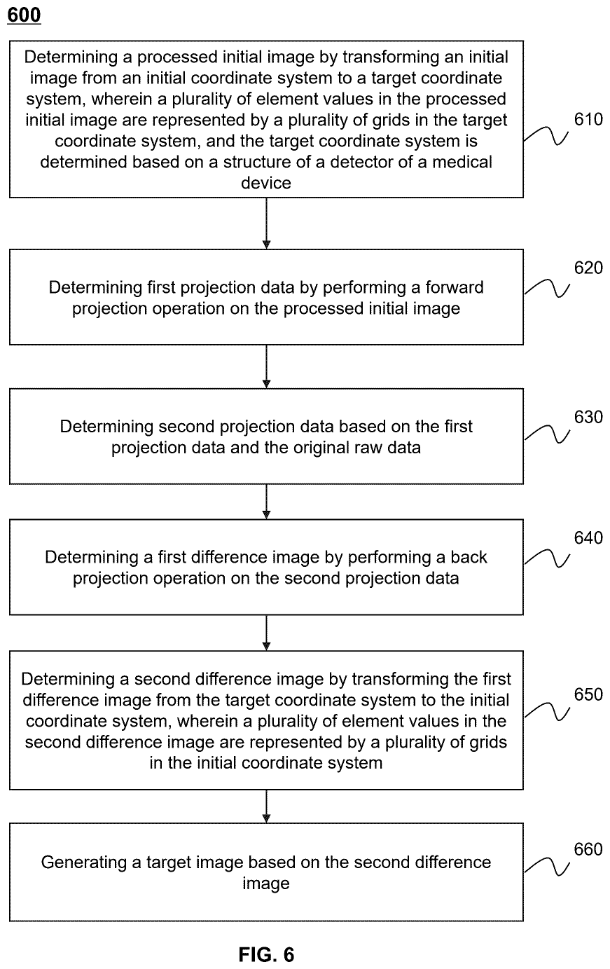

In some embodiments, the processing device 120 may generate the target image by iteratively updating the initial image according to the iterative reconstruction algorithm. The initial image may be iteratively updated by optimizing a target function. The target function may be determined based on the original raw data, the initial image (or an updated image), and a regularization term. As used herein, the regularization item may refer to an item that may be used to regularize the original raw data during an image reconstruction process. In some embodiments, the regularization item may include a total-variation-based (TV based) regularization item, a Tikhonov regularization item, a bilateral total variation regularization item, a local information adaptive total variation regularization item, or the like, or any combination thereof. More descriptions for generating the target image may be found elsewhere in the present disclosure (e.g., FIGS. 6-8 and descriptions thereof).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, operation 510 and operation 520 may be combined into a single operation.

FIG. 6 is a flowchart illustrating an exemplary process for generating a target image according to some embodiments of the present disclosure. In some embodiments, process 600 may be executed by the medical system 100. For example, the process 600 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 600. The operations of the illustrated process presented below are intended to be illustrative. In some embodiments, the process 600 may be accomplished with one or more additional operations not described and/or without one or more of the operations discussed. Additionally, the order of the operations of process 600 illustrated in FIG. 6 and described below is not intended to be limiting.

In some embodiments, one or more operations of process 600 may be performed to achieve at least part of operation 530 as described in connection with FIG. 5. For example, the process 600 may be performed to achieve a current iteration in an iterative image reconstruction process.

In 610, the processing device 120 (e.g., the determination module 430) may determine a processed initial image by transforming an initial image from an initial coordinate system to a target coordinate system. A plurality of element values in the processed initial image may be represented by a plurality of grids in the target coordinate system. The plurality of grids in the target coordinate system may include integer grids and non-integer grids.

In some embodiments, the initial coordinate system and the target coordinate system may include a Cartesian coordinate system, a polar coordinate system, a cylindrical coordinate system, or a spherical coordinate system, which is not limited herein. The initial coordinate system and the target coordinate system may be different.

In some embodiments, the target coordinate system may be determined based on a structure of a detector of the medical device.

In some embodiments, the structure of the detector may refer to an arrangement manner of the detector of the medical device. The target coordinate system may be determined based on the arrangement manner of the detector of the medical device.

Merely for illustration purposes and not limiting the scope of the present disclosure, the following descriptions are illustrated by taking the Cartesian coordinate system as the initial coordinate system and the polar coordinate system as the target coordinate system as an example.

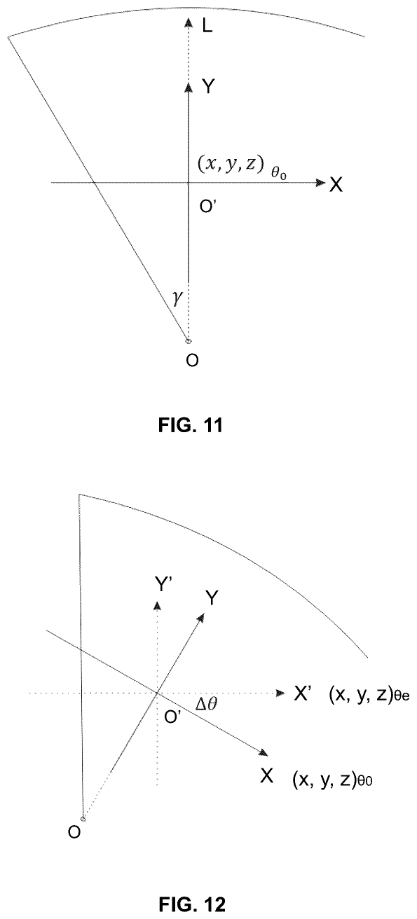

In some embodiments, the processing device 120 may establish a reference Cartesian coordinate system corresponding to a reference projection angle. The reference projection angle may be manually set by a user of the medical system 100, or determined by one or more components (e.g., the processing device 120) of the medical system 100. In some embodiments, an origin (e.g., an origin O′ as illustrated in FIG. 11) of the reference Cartesian coordinate system may be located at a rotation center of a gantry of the medical device. A first axis direction (e.g., a Y-axis direction as illustrated in FIG. 11) of the reference Cartesian coordinate system may be along a line connecting the origin and a detector unit of a plurality of detector units of a detector of the medical device. A second axis direction (e.g., an X-axis direction as illustrated in FIG. 11) of the reference Cartesian coordinate system may be perpendicular to the first axis of the reference Cartesian coordinate system. The second axis direction may be in a plane perpendicular to a detector plane. A third axis direction of the reference Cartesian coordinate system may be perpendicular to a plane formed by the first axis direction and the second axis direction of the reference Cartesian coordinate system.

In some embodiments, the reference Cartesian coordinate system may include a plurality of grids. In the present disclosure, an image in the reference Cartesian coordinate system may refer to that the image (e.g., a plurality of element values of a plurality of elements (e.g., pixels, voxels) in the image) are represented by a plurality of integer grids in the reference Cartesian coordinate system. For example, each element of the image may correspond to an integer grid in the reference Cartesian coordinate system. In some embodiments, a size of each grid of the plurality of grids may be (substantially) the same or different. In some embodiments, a size of each grid of the plurality of grids of the reference Cartesian coordinate system may be related to a size of an element of a reconstructed image and a range of a subject for image reconstruction.

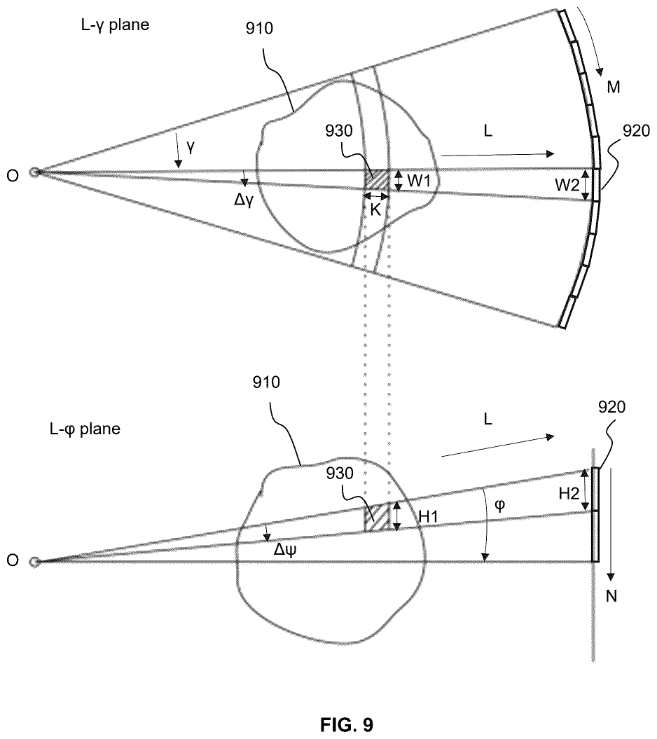

In some embodiments, the processing device 120 may establish the polar coordinate system. In some embodiments, the polar coordinate system may be established based on a structure of the detector of the medical device. For example, the detector (e.g., a curved surface detector) of a CT device may include a plurality of detector units. The plurality of detector units may include at least one row of detector units arranged along a first direction (e.g., an M direction as illustrated in FIG. 9) and at least one column of detector units arranged along a second direction (e.g., an N direction as illustrated in FIG. 9). In some embodiments, when the tube is located at a position directly above the scanning table of the medical device and the detector is located at a position directly below the scanning table of the medical device, the first direction may be substantially parallel to the R-axis direction of the medical coordinate system 160 as illustrated in FIG. 1, and the second direction may be parallel to the S-axis direction of the medical coordinate system 160 as illustrated in FIG. 1. An origin (e.g., an origin O as illustrated in FIGS. 9-11) of the polar coordinate system may be located at a focal spot of a tube of the medical device. A first axis direction of the polar coordinate system may be the same as the first axis direction of the reference Cartesian coordinate system. For example, the first axis direction (e.g., an L-axis direction as illustrated in FIG. 9, an L-axis direction as illustrated in FIG. 11) of the polar coordinate system may be along a line connecting the origin and a detector unit of the plurality of detector units of the detector of the medical device. A second axis direction (e.g., a y-axis direction as illustrated in FIG. 9) of the polar coordinate system may be an angle direction between a line connecting the origin and a detector unit of the at least one row of detector units and the first axis direction of the polar coordinate system. A third axis direction (e.g., a q-axis direction as illustrated in FIG. 9) of the polar coordinate system may be an angle direction between a line connecting a detector unit of the plurality of detector units and the origin, and a plane formed by the first axis direction and the second axis direction of the polar coordinate system (also referred to as the L-y plane).

In some embodiments, the polar coordinate system may include a plurality of grids. In the present disclosure, an image in the polar coordinate system may refer to that the image (e.g., a plurality of element values of a plurality of elements (e.g., pixels, voxels) in the image) are represented by a plurality of integer grids in the polar coordinate system. In some embodiments, a size of each grid of the plurality of grids may be (substantially) the same or different. In some embodiments, the size of each grid of the plurality of grids may be related to a size of a corresponding detector unit of the plurality of detector units. In some embodiments, a width of the grid along the second axis direction of the polar coordinate system may be related to a width of a corresponding detector unit along the first direction. For example, a width of a detector unit along the first direction may be an integer multiple of a width of a corresponding grid along the second axis direction of the polar coordinate system. In some embodiments, a height of the grid along the third axis direction of the polar coordinate system may be related to a height of the corresponding detector unit along the second direction. For example, a height of a detector unit along the second direction may be an integer multiple of a height of a corresponding grid along the third axis direction of the polar coordinate system.

In some embodiments, polar coordinates of a grid (corresponding to an element value of an element at the grid) in the polar coordinate system may be determined according to Equation (1):

$$\{ \begin{matrix}{l}_{i} = i * Δ l \\ {γ}_{j} ( {l}_{i} ) = j * Δγ ( {l}_{i} ) \\ {φ}_{k} ( {T}_{s} ) = {φ}_{k - 1} + ( {Δφ}_{k - 1} ( {T}_{{s}^{′}} ) + {Δφ}_{k} ( {T}_{s} ) ) / 2\end{matrix} , \qquad ( 1 )$$

where lᵢ, γⱼ(lᵢ), and φₖ(Tₛ) refer to polar coordinates (e.g., a first axis coordinate, a second axis coordinate, a third axis coordinate) of a grid (i,j,k) in a polar coordinate system; Δl refers to a length of the grid along the first axis direction of the polar coordinate system; Δγ(lᵢ) refers to an angle corresponding to a width of the grid along the second axis direction of the polar coordinate system; φₖ₋₁ refers to a third coordinate of a grid (i, j, k−1) in a polar coordinate system; Δφₖ₋₁(T_{s′}) refers to a height of the grid (i, j, k−1) (corresponding to a detector unit T_{s′}) along the third axis direction of the polar coordinate system; Δφₖ(Tₛ) refers to an angle corresponding to a height of the grid (i, j, k) (corresponding to a detector unit Tₛ) along the third axis direction of the polar coordinate system. In some embodiments, the grid (i, j, k) and the grid (i, j, k−1) may correspond to a same detector unit, and Tₛ and T_{s′} may be a same detector unit. In some embodiments, the grid (i, j, k) and the grid (i, j, k−1) may correspond to two adjacent detector units, and Tₛ and T_{s′} may be two different detector units.

In some embodiments, an angle formed between two sides of the grid along the second axis direction of the polar coordinate system (also referred to an angle corresponding the width) (e.g., an angle Δγ as illustrated in FIG. 9) may be determined according to Equation (2):

$$Δγ ( {l}_{i} ) = {Δγ}^{′} / n ( {l}_{i} ) , \qquad ( 2 )$$

where Δ_{y}(lᵢ) refers to an angle corresponding to a width of a grid along the second axis direction of the polar coordinate system; γγ′ refers to an angle corresponding to a width of a corresponding detector unit along the first direction; and n(lᵢ) refers to an integer.

In some embodiments, an angle formed between two sides of the grid along the third axis direction of the polar coordinate system (also referred to an angle corresponding the height) (e.g., an angle Δφ as illustrated in FIG. 9) may be determined according to Equation (3):

$${Δφ}_{j} ( {T}_{s} ) = {φ}_{s} / n ( {T}_{s} ) , \qquad ( 3 )$$

where Δφⱼ(Tₛ) refers to an angle corresponding to a height of a grid along the third axis direction of the polar coordinate system; φₛ refers to an angle between a first line connecting an origin and a first side (e.g., an upper side) of a detector unit Tₛ, and a second line connecting the origin and a second side (opposite to the first side) (e.g., a lower side) of the detector unit Tₛ; and n(Tₛ) refers to an integer. The first side or the second side of the detector unit Tₛ may be along the first axis direction of the polar coordinate system. In some embodiments, φₛ may be determined according to Equation (4):

$${φ}_{s} = atan \frac{s * Δ {t}^{′}}{{S}_{t}} - atan \frac{( s - 1 ) * Δ {t}^{′}}{{S}_{t}} , \qquad ( 4 )$$

where Sₜ refers to a distance between a focal spot of a tube of the medical device and a detector of the medical device; s refers to a serial number of the detector unit in a column of detector units; and Δt′ refers to a height of the detector unit along the second direction.

In some embodiments, the shape of each grid in the L-γ plane may be approximated as a square. For example, a length of the each grid of the plurality of grids along the first axis direction of the polar coordinate system may be substantially the same as the width of the each grid of the plurality of grids along the second axis direction of the polar coordinate system.

FIG. 9 is a schematic diagram illustrating an exemplary polar coordinate system according to some embodiments of the present disclosure. As illustrated in FIG. 9, a subject 910 may be scanned by a medical device. The medical device may include a plurality of detector units (e.g., a detector unit 920). The plurality of detector units may include at least one row of detector units arranged along a first direction M, and at least one column of detector units arranged along a second direction N. The polar coordinate system may include an origin O, a first axis direction L, a second axis direction γ, and a third axis direction φ. The polar coordinate system may include a plurality of grids (e.g., a grid 930). The size of each grid of the plurality of grids may be related to a size of a corresponding detector unit of the plurality of detector units. As shown in FIG. 9, the size of the grid 930 may be related to a size of the detector unit 920. For example, a width W1 of the grid 930 along the second axis direction γ of the polar coordinate system may be related to a width W2 of the detector unit 920 along the first direction M. A height H1 of the grid 930 along the third axis direction o of the polar coordinate system may be related to a height H2 of the detector unit 920 along the second direction N. A length K of the grid 930 along the first axis direction L of the polar coordinate system may be substantially the same as the width W1 of the grid 930 along the second axis direction γ of the polar coordinate system.

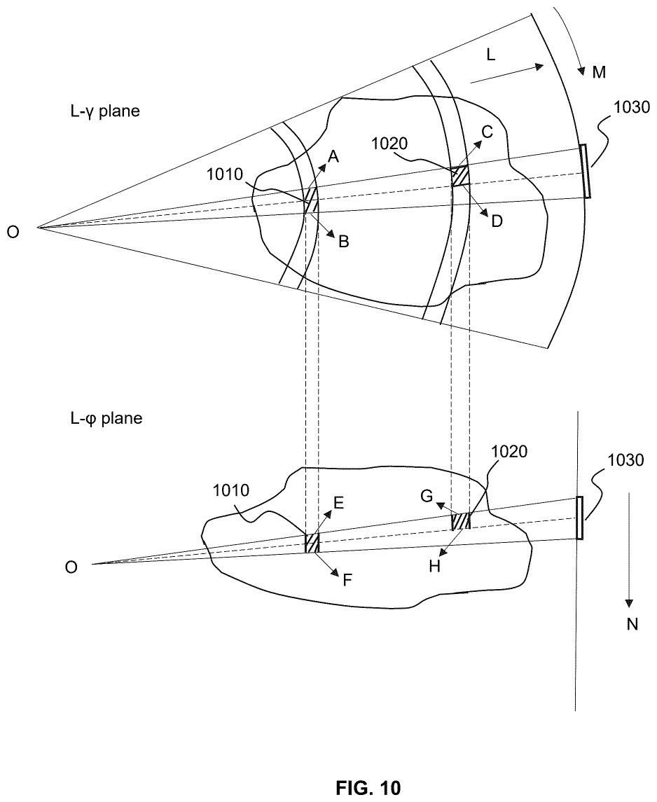

In some embodiments, under a condition that a grid is in a constant size, the farther a grid is from the origin of the polar coordinate system along the first axis direction, the smaller an angle between two sides of the grid along the first axis direction (also referred to as an angle corresponding to the width of the grid). FIG. 10 is a schematic diagram illustrating exemplary grids in a polar coordinate system according to some embodiments of the present disclosure. As illustrated in FIG. 10, a distance between the origin O and the grid 1020 may be longer than a distance between the origin O and the grid 1010. An angle between a side C and a side D of the grid 1020 along the first axis direction L may be smaller than an angle between a side A and a side B of the grid 1010 along the first axis direction L. An angle between a side G and a side H of the grid 1020 may be smaller than an angle between a side E and a side F of the grid 1010. Accordingly, the size of the grid 1020 may be substantially the same as the size of the grid 1010.

In some embodiments, one detector unit may correspond to one or more grids along the first direction M and/or the second direction N. For example, the detector unit 1030 may correspond to one grid 1010 along the first direction M and the second direction N. As another example, the detector unit 1030 may correspond to at least two grids 1020 along the first direction M or the second direction N. In some embodiments, if a size of a detector unit (e.g., the width of the detector unit along the first direction M, the height of the detector unit along the second direction N) is relatively small (e.g., smaller than a threshold), a plurality of detector units may correspond to one grid along the first direction M and/or the second direction N.

It should be noted that the detector units and the grids in the polar coordinate system shown in FIGS. 9 and 10 are merely provided for the purposes of illustration, and not intended to limit the scope of the present disclosure. The detector of the medical device may have any shape. The grid in the polar coordinate system may have any shape. For example, the detector may be a flat panel detector with a square or rectangular shape. The grid in the polar coordinate system may have a square or rectangular shape.

In some embodiments, a projected edge of the plurality of grids on a detector plane may be coincident with or parallel to an edge of the detector. As used herein, a detector plane refers to a plane perpendicular to the first axis direction L of the polar coordinate system.

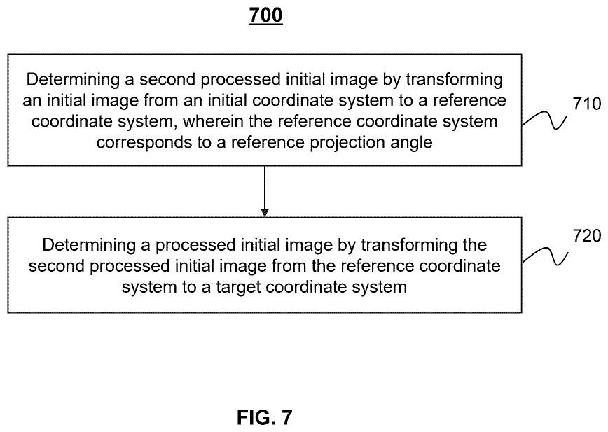

In some embodiments, original raw data may correspond to one or more initial projection angles. For example, part of the original raw data may be obtained by the medical device when the medical device is located at an initial projection angle of the one or more initial projection angles. The initial projection angle(s) may be different from the reference projection angle. The processing device 120 may determine a second processed initial image by transforming the initial image from the initial Cartesian coordinate system to the reference Cartesian coordinate system. The processing device 120 may determine the processed initial image by transforming the second processed initial image from the reference Cartesian coordinate system to the polar coordinate system. More descriptions for determining a processed initial image may be found elsewhere in the present disclosure (e.g., FIG. 7 and descriptions thereof).

In 620, the processing device 120 (e.g., the determination module 430) may determine first projection data by performing a forward projection operation on the processed initial image.

According to the forward projection operation, the processing device 120 may transform data (e.g., the processed initial image) in an image domain to data (e.g., the first projection data) in a projection domain. In some embodiments, the processing device 120 may transform the processed initial image into the first projection data by multiplying processed initial image by a forward projection matrix. In some embodiments, the forward projection matrix may be a default setting of the medical system 100 or may be adjustable under different situations.

In some embodiments, the processing device 120 may determine the first projection data according to Equation (5):

$$P [ {γ}_{m} , {t}_{n} ] = {\sum }_{i ∈ all , j ∈ \{ {γ}_{m} \} , k ∈ \{ {t}_{n} \}} \frac{{V}_{i , j , k} * U [ {l}_{i} , {γ}_{j} , {φ}_{k} ]}{{Δγ}^{′} * Δ {t}^{′}} , \qquad ( 5 )$$

where P[γₘ, tₙ] refers to projection data (e.g., the first projection data); V_{i,j,k} refers to an element volume of an element (e.g., a voxel) in an image (e.g., the processed initial image); Δγ′ refers to an angle corresponding to a width of a detector unit along the first direction; Δt′ refers to an angle corresponding to a height of the detector unit along the second direction; U[lᵢ, γⱼ>φₖ] refers to an element value of the element (e.g., a voxel) in the image (e.g., the processed initial image); i refers to a number (or count) of elements along a path of a ray emitted by a tube of a medical device; j and k refer to a number (or count) of elements corresponding to a detector unit [m, n], wherein m and n refers to a serial number of the detector unit in at least one row of detector units and at least one column of detector units, respectively. In some embodiments, the element volume of the element in the image may be determined based on a location of the element in a coordinate system and a relationship between the element volume of the element and the location of the element. For example, the relationship between the element volume of the element and the location of the element may be represented as Equation (6):

$${V}_{i , j , k} = V ( {l}_{i} , {γ}_{j} , {φ}_{k} ) , \qquad ( 6 )$$

where V_{i,j,k} refers to an element volume of an element (e.g., a voxel) in an image; V refers to a functional relationship; and (lᵢ, γⱼ, φₖ) refers to a location of the element in a coordinate system (e.g., polar coordinates of the element in the polar coordinate system).

Accordingly, a plurality of elements of an image (e.g., the processed initial image) may be discretized according to the structure of the detector of the medical device, and a projected edge of the plurality of elements on the detector plane may be coincident with or parallel to the edge of the detector. When the forward projection operation is performed on the processed initial image, the summation operation may be performed on an integer number of elements, which may improve the computing speed of the forward projection operation, and accordingly improve the efficiency of image reconstruction.

In 630, the processing device 120 (e.g., the determination module 430) may determine second projection data based on the first projection data and the original raw data.

In some embodiments, the processing device 120 may determine the second projection data based on a difference between the first projection data and the original raw data. For example, the processing device 120 may determine the second projection data by subtracting the first projection data (or the original raw data) from the original raw data (or the first projection data). As another example, the processing device 120 may determine a ratio between the first projection data and the original raw data as the second projection data.

In 640, the processing device 120 (e.g., the determination module 430) may determine a first difference image by performing a back projection operation on the second projection data.

According to the back projection operation, the processing device 120 may transform data (e.g., the second projection data) in a projection domain to data (e.g., the first difference image) in an image domain. In some embodiments, the processing device 120 may transform the second projection data into the first difference image by multiplying the second projection data by a back projection matrix. In some embodiments, the back projection matrix may be a default setting of the medical system 100 or may be adjustable under different situations.

In some embodiments, the processing device 120 may determine the first difference image according to Equation (7):

$$U [ {l}_{i} , {γ}_{j} , {φ}_{k} ] = \frac{{Δγ}^{′} * Δ {t}^{′} * P [ {γ}_{m} , {t}_{n} ]}{{V}_{i , j , k}} , \qquad ( 7 )$$

where P[γₘ, tₙ] refers to projection data (e.g., the second projection data); V_{i,j,k} refers to an element volume of an element (e.g., a voxel) in an image; Δy′ refers to an angle corresponding to a width of a detector unit along the first direction; Δt′ refers to an angle corresponding to a height of the detector unit along the second direction; U[lᵢ, γⱼ, φₖ] refers to an element value of the element (e.g., a voxel) in the image (e.g., the first difference image); i refers to a number (or count) of elements along a path of a ray emitted by a tube of a medical device; j and k refer to a number (or count) of elements corresponding to a detector unit [m, n], wherein m and n refers to a serial number of the detector unit in at least one row of detector units and at least one column of detector units, respectively.

In 650, the processing device 120 (e.g., the determination module 430) may determine a second difference image by transforming the first difference image from the target coordinate system to the initial coordinate system. A plurality of element values in the second difference image may be represented by a plurality of grids in the initial coordinate system. The plurality of grids in the initial coordinate system may include integer grids and non-integer grids.

Merely for illustration purposes and not limiting the scope of the present disclosure, the following descriptions are illustrated by taking the Cartesian coordinate system as the initial coordinate system and the polar coordinate system as the target coordinate system as an example.

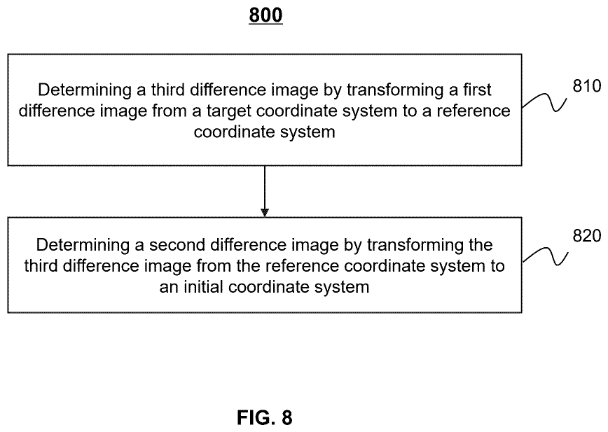

In some embodiments, the processing device 120 may determine a third difference image by transforming the first difference image from the polar coordinate system to the reference Cartesian coordinate system. The processing device 120 may determine the second difference image by transforming the third difference image from the reference Cartesian coordinate system to the initial Cartesian coordinate system. More descriptions for determining a second difference image may be found elsewhere in the present disclosure (e.g., FIG. 8 and descriptions thereof).

In 660, the processing device 120 (e.g., the determination module 430) may generate the target image based on one or more second difference images. In some embodiments, the one or more second difference images may correspond to the one or more initial projection angles.

In some embodiments, the processing device 120 may update the initial image based on a plurality of initial projection angles and determine an updated image as the target image. Merely by way of example, in a first iteration, the processing device 120 may determine a second difference image based on the initial image and a first initial projection angle as described in connection with operations 610-650 and obtain a first updated image by updating the initial image based on the second difference image; in a second iteration, the processing device 120 may determine an updated second difference image based on the first updated image and a second initial projection angle as described in connection with operations 610-650 and obtain a second updated image by updating the first updated image based on the updated second difference image. In an nth iteration, the processing device 120 may determine an updated second difference image based on the nth updated image and an nth initial projection angle as described in connection with operations 610-650 and obtain an nth updated image by updating the (n−1)th updated image based on the updated second difference image. The processing device 120 may determine the nth updated image as the target image.

Taking an image reconstruction process according to a gradient descent algorithm as an example, the processing device 120 may determine a first gradient descent value based on a second difference image and a regularization term. The processing device 120 may determine the second difference image based on the initial image and an initial projection angle of the one or more initial projection angles as described in connection with operations 610-650. The processing device 120 may update the initial image based on the first gradient descent value. For example, the processing device 120 may generate a first updated image by adding the first gradient descent value to the initial image.

In a next iteration, based on another initial projection angle of the one or more initial projection angles, the processing device 120 may determine a processed first updated image by transforming the first updated image from the initial Cartesian coordinate system to the polar coordinate system, as described in connection with operation 610. The processing device 120 may determine updated first projection data by performing a forward projection operation on the processed first updated image, as described in connection with operation 620. The processing device 120 may determine updated second projection data based on the updated first projection data and the original raw data, as described in connection with operation 630. The processing device 120 may determine an updated first difference image by performing a back projection operation on the updated second projection data, as described in connection with operation 640. The processing device 120 may determine an updated second difference image by transforming the updated first difference image from the polar coordinate system to the initial Cartesian coordinate system, as described in connection with operation 650. The processing device 120 may determine a second gradient descent value based on the updated second difference image and the regularization term. The processing device 120 may update the first updated image based on the second gradient descent value to generate a second updated image.

In some embodiments, the processing device 120 may update the initial image based on at least two second difference images.

Taking the image reconstruction process according to the gradient descent algorithm as an example, the processing device 120 may determine a first gradient descent value (e.g., an average value, a weighted value, etc., of gradient descent values corresponding to the at least two second difference images) based on the gradient descent values corresponding to the at least two second difference images and a regularization term. The processing device 120 may determine the at least two second difference images based on the initial image and at least two initial projection angles of the one or more initial projection angles as described in connection with operations 610-650. The processing device 120 may update the initial image based on the first gradient descent value. For example, the processing device 120 may generate a first updated image by adding the first gradient descent value to the initial image.

In a next iteration, the processing device 120 may determine the first updated image as the updated initial image and determine at least two updated second difference images based on the first updated image and another at least two initial projection angles of the one or more initial projection angles as illustrated above. The processing device 120 may determine a second gradient descent value based on gradient descent values corresponding to the at least two updated second difference images and the regularization term. The processing device 120 may update the first updated image based on the second gradient descent value to generate a second updated image.

In some embodiments, operation 610-660 may be repeated until a termination condition is satisfied. In some embodiments, in response to determining that the termination condition is satisfied in a current iteration, the processing device 120 may determine an updated image (e.g., the first updated image, the second updated image, etc.) in the current iteration as the target image. The termination condition may be related to the target function or an iteration count of the iterative process. For example, the termination condition may be satisfied if the value of the target function is minimal or smaller than a threshold. As another example, the termination condition may be satisfied when a specified number (or count) of iterations are performed in the image reconstruction process.

In some embodiments, the processing device 120 may update the initial image based on the one or more second difference images. Taking the image reconstruction process according to the gradient descent algorithm as an example, the processing device 120 may determine one or more gradient descent values based on the one or more second difference images and a regularization term. The processing device 120 may determine the one or more second difference images based on the initial image and the one or more initial projection angles as described in connection with operations 610-650. The processing device 120 may update the initial image based on the one or more gradient descent values. For example, the processing device 120 may determine an average gradient descent value or a weighted average gradient descent value of the one or more gradient descent values to generate an updated image by adding the average gradient descent value or the weighted average gradient descent value to the initial image.

In some embodiments, the processing device 120 may determine the updated image as the target image.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 7 is a flowchart illustrating an exemplary process for determining a processed initial image according to some embodiments of the present disclosure. In some embodiments, process 700 may be executed by the medical system 100. For example, the process 700 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 700. The operations of the illustrated process presented below are intended to be illustrative. In some embodiments, the process 700 may be accomplished with one or more additional operations not described and/or without one or more of the operations discussed. Additionally, the order of the operations of process 700 illustrated in FIG. 7 and described below is not intended to be limiting. In some embodiments, one or more operations of the process 700 may be performed to achieve at least part of operation 610 as described in connection with FIG. 6.

In 710, the processing device 120 (e.g., the determination module 430) may determine a second processed initial image by transforming an initial image from an initial coordinate system to a reference coordinate system. The reference coordinate system may correspond to a reference projection angle. The reference coordinate system may include a plurality of grids. The plurality of grids may include integer grids and non-integer grids.

In some embodiments, the reference coordinate system may include a Cartesian coordinate system, a polar coordinate system, a cylindrical coordinate system, or a spherical coordinate system, which is not limited herein.

Merely for illustration purposes and not limiting the scope of the present disclosure, the following descriptions are illustrated by taking the Cartesian coordinate system as the initial coordinate system and the polar coordinate system as the target coordinate system as an example.

In some embodiments, the processing device 120 may determine the second processed initial image by transforming the initial image from the initial Cartesian coordinate system corresponding to the initial projection angle to a reference Cartesian coordinate system corresponding to the reference projection angle.

FIG. 11 is a schematic diagram illustrating an exemplary reference Cartesian coordinate system and an exemplary polar coordinate system according to some embodiments of the present disclosure. FIG. 12 is a schematic diagram illustrating an exemplary reference Cartesian coordinate system and an exemplary initial Cartesian coordinate system according to some embodiments of the present disclosure. As illustrated in FIGS. 11 and 12, a reference Cartesian coordinate system (x,y,z)_{θ}_{₀} may include an origin O′, an X-axis direction, a Y-axis direction, and a Z-axis direction (not shown in FIGS. 11 and 12). A first axis direction L of a polar coordinate system (l,γ,φ) may be the same as the X-axis direction of the reference Cartesian coordinate system (x,y,z)_{θ}_{₀}. An initial Cartesian coordinate system (x,y,z)_{θ}_{ₑ} may include the origin O′, an X′-axis direction, a Y′-axis direction, and a Z′-axis direction (not shown in FIGS. 11 and 12). The reference Cartesian coordinate system (x,y,z)_{θ}_{₀} may correspond to a reference projection angle θ₀. The initial Cartesian coordinate system (x,y,z)_{θ}_{ₑ} may correspond to an initial projection angle θ₀. An angle between an axis direction (e.g., the X-axis direction, the Y-axis direction) of the reference Cartesian coordinate system and an axis direction (e.g., the X′-axis direction, the Y′-axis direction) of the initial Cartesian coordinate system may be determined as θₑ−θ₀=Δθ. In some embodiments, the processing device 120 may determine a transformation relationship (e.g., a rotation matrix) between the reference Cartesian coordinate system (x,y,z)_{θ}_{₀} and the initial Cartesian coordinate system (x,y,z)_{θ}_{ₑ}. For example, coordinates of an element in the initial Cartesian coordinate system (x,y,z)_{θ}_{ₑ} may be determined by multiplying coordinates of a corresponding element in the reference Cartesian coordinate system (x,y,z)_{θ}_{₀} and the rotation matrix.

In the present disclosure, a plurality of elements (e.g., pixels, voxels) in an image may correspond to a plurality of grids in a coordinate system respectively, so that a plurality of element values of the plurality of elements in the image may be represented by the plurality of grids in the coordinate system. For example, for each of the plurality of elements in the image, a location (i.e., a grid where the element is located in) of the element in the coordinate system may be determined based on the origin of the coordinate system and a spacing between adjacent elements along the coordinate axes. The origin of the coordinate system may correspond to the origin of the image. Merely by way of example, the processing device 120 may obtain a plurality of element values of a plurality of elements at a plurality of grids in the initial coordinate system based on a plurality of element values of the plurality of elements in the image. Each of the plurality of element values of the plurality of elements in the image may correspond to an element value of an element at a grid in the initial coordinate system. The plurality of element values of the plurality of elements at the plurality of grids in the initial coordinate system may correspond to a plurality of element values of a plurality of elements at a plurality of grids in the reference coordinate system respectively based on a transformation relationship, and the plurality of element values of the plurality of elements at the plurality of grids in the reference coordinate system may correspond to a plurality of element values of a plurality of elements at a plurality of grids in the target coordinate system respectively based on a transformation relationship. More details about the transformation relationship may be found elsewhere in the present disclosure, such as FIG. 7 and the related descriptions thereof.

In some embodiments, the processing device 120 may obtain a plurality of element values of a plurality of elements at a plurality of grids (e.g., integer grids) in the reference Cartesian coordinate system by performing an interpolation operation on the plurality of element values of the plurality of elements at the plurality of grids (e.g., integer grids) in the initial Cartesian coordinate system. For example, the processing device 120 may obtain a plurality of element values of a plurality of elements at a plurality of non-integer grids in the initial Cartesian coordinate system by performing the interpolation operation on the plurality of element values of the plurality of elements at the plurality of integer grids in the initial Cartesian coordinate system. The plurality of non-integer grids in the initial Cartesian coordinate system may correspond to a plurality of integer grids in the reference coordinate system. As used herein, an integer grid in a coordinate system refers to that coordinates of the grid are integers, and a non-integer grid in a coordinate system refers to that coordinates of the grid are non-integers. The interpolation operation may be performed based on a nearest neighbor interpolation algorithm, a multi-spline interpolation algorithm, a trilinear interpolation algorithm, a deep learning algorithm, or the like, or any combination thereof.

Merely by way of example, the processing device 120 may determine the plurality of element values of the plurality of elements at the plurality of integer grids in the reference Cartesian coordinate system according to Equation (8):

$${U [ x , y , z ]}_{{θ}_{0}} = {U ( {x}^{′} , {y}^{′} , {z}^{′} )}_{{θ}_{e}} = LinIter 3 {D}_{CART} ( {U [ x , y , z ]}_{{θ}_{e}} ) , \qquad ( 8 )$$

where U[x,y,z]_{θ}_{ₑ} refers to an element value of an element at an integer grid in the initial Cartesian coordinate system; U(x′,y′,z′)_{θ}_{ₑ} refers to an element value of an element at a non-integer grid in the initial Cartesian coordinate system; U[x,y,z]_{θ}_{₀} refers to an element value of an element at an integer grid in the reference Cartesian coordinate system; and LinIterp3D_{CART} refers to an interpolation operation (e.g., a trilinear interpolation operation).

The processing device 120 may obtain the plurality of element values of the plurality of elements at the plurality of integer grids in the reference Cartesian coordinate system based on the plurality of element values of the plurality of elements at the plurality of non-integer grids in the initial Cartesian coordinate system. For example, a transformation relationship between a coordinate of an element at a non-integer grid in the initial Cartesian coordinate system and a coordinate of an element at an integer grid in the reference Cartesian coordinate system may be determined according to Equations (9)-(10):

$${( \begin{matrix}{x}^{′} \\ {y}^{′}\end{matrix} )}_{{θ}_{e}} = ( \begin{matrix}sin Δθ & cos Δθ \\ cos Δθ & - sin Δθ\end{matrix} ) {( \begin{matrix}x \\ y\end{matrix} )}_{{θ}_{0}} , \qquad ( 9 )$$

$${z}_{{θ}_{0}}^{′} = {z}_{{θ}_{e}} , \qquad ( 10 )$$

where (x′,y′,z′)_{θ}_{ₑ} refers to a coordinate of an element in the initial Cartesian coordinate system; (x,y,z)_{θ}_{₀} refers to a coordinate of an element in the reference Cartesian coordinate system; and

$$( \begin{matrix}sin Δθ & cos Δθ \\ cos Δθ & - sin Δθ\end{matrix} )$$

refers to a rotation matrix. Accordingly, the element value (U(x′,y′, z′)_{θ}_{ₑ}) of the element at the non-integer grid in the initial Cartesian coordinate system may be the same as the element value (U[x,y,z]_{θ}_{₀}) of the element at the integer grid in the reference Cartesian coordinate system. According to Equation (8), the element value (U(x′,y′,z′)_{θ}_{ₑ}) of the element at the non-integer grid in the initial Cartesian coordinate system may be determined by performing an interpolation operation on a plurality of element values of a plurality of elements at a plurality of integer grids in the initial Cartesian coordinate system. In some embodiments, the transformation relationship between the coordinate of the element at the non-integer grid in the initial Cartesian coordinate system and the coordinate of the element at the integer grid in the reference Cartesian coordinate system may be stored in a storage device (e.g., the storage device 130) of the medical system 100.

Further, the processing device 120 may determine the second processed initial image based on the plurality of element values of the plurality of elements at the plurality of grids (e.g., integer grids) in the reference Cartesian coordinate system. For example, the processing device 120 may determine the second processed initial image by combining the plurality of element values of the plurality of elements at the plurality of integer grids in the reference Cartesian coordinate system.

In 720, the processing device 120 (e.g., the determination module 430) may determine a processed initial image by transforming the second processed initial image from the reference coordinate system to a target coordinate system.

Merely for illustration purposes and not limiting the scope of the present disclosure, the following descriptions are illustrated by taking the Cartesian coordinate system as the initial coordinate system and the polar coordinate system as the target coordinate system as an example.

In some embodiments, the processing device 120 may obtain a plurality of element values of a plurality of elements at a plurality of non-integer grids in the reference Cartesian coordinate system by performing an interpolation operation on a plurality of element values of a plurality of elements at a plurality of integer grids in the reference Cartesian coordinate system. The plurality of non-integer grids in the reference Cartesian coordinate system may correspond to a plurality of integer grids in the polar coordinate system.

For example, the processing device 120 may obtain the plurality of element values of the plurality of elements at the plurality of non-integer grids in the reference Cartesian coordinate system according to Equation (11):

$$U [ {l}_{i} , {γ}_{j} , {φ}_{k} ] = U ( {x}_{{θ}_{0}} , {y}_{{θ}_{0}} , {z}_{{θ}_{0}} ) = LinIter 3 {D}_{CART} ( U [ {x}_{u} , {y}_{v} , {z}_{w} ] ) , \qquad ( 11 )$$

where U[lᵢ,γⱼ,φₖ] refers to an element value of an element at an integer grid in the polar coordinate system; U(x_{θ}_{₀},y_{θ}_{₀},z_{θ}_{₀}) refers to an element value of an element at a non-integer grid in the reference Cartesian coordinate system; U[xᵤ,yᵥ,z_{w}] refers to an element value of an element at an integer grid in the reference Cartesian coordinate system; and LinIterp3D_{CART} refers to an interpolation operation (e.g., a trilinear interpolation operation).

The processing device 120 may obtain a plurality of element values of a plurality of elements at the plurality of integer grids in the polar coordinate system based on the plurality of element values of the plurality of elements at the plurality of non-integer grids in the reference Cartesian coordinate system. For example, a transformation relationship between a coordinate of an element at a non-integer grid in the reference Cartesian coordinate system and a coordinate of an element at an integer grid in the polar coordinate system may be determined according to Equations (12)-(14):

$${x}_{{θ}_{0}} ( {l}_{i} , {γ}_{j} , {φ}_{k} ) = {l}_{i} * sin {γ}_{j} , \qquad ( 12 )$$

$${y}_{{θ}_{0}} ( {l}_{i} , {γ}_{j} , {φ}_{k} ) = {l}_{i} * cos {γ}_{j} - {S}_{o} , \qquad ( 13 )$$

$${z}_{{θ}_{0}} ( {l}_{i} , {γ}_{j} , {φ}_{k} ) = {l}_{i} * tan {φ}_{k} , \qquad ( 14 )$$

where Sₒ refers to a distance between a focal spot of a tube of a medical device and a rotation center of a gantry of the medical device; (lᵢ,γⱼ,φₖ) refers to a coordinate of the element at the integer grid in the polar coordinate system; and (x_{θ}_{₀}(lᵢ,γⱼ,φₖ), y_{θ}_{₀}(lᵢ,γⱼ,φₖ), z_{θ}_{₀}(lᵢ,γⱼ,φₖ)) refers to a coordinate of an element at a non-integer grid in the reference Cartesian coordinate system. Accordingly, the element value (U(x_{θ}_{₀},y_{θ}_{₀},z_{θ}_{₀})) of the element at the non-integer grid in the reference Cartesian coordinate system may be the same as the element value (U[lᵢ,γⱼ,φₖ]) of the element at the integer grid in the polar coordinate system. According to Equation (11), the element value (U(x_{θ}_{₀},γ_{θ}_{₀},z_{θ}_{₀})) of the element at the non-integer grid in the reference Cartesian coordinate system may be determined by performing an interpolation operation on a plurality of element values of a plurality of elements at a plurality of integer grids in the reference Cartesian coordinate system. In some embodiments, the transformation relationship between the element value of the element in the reference Cartesian coordinate system and the element value of the element in the polar coordinate system may be stored in a storage device (e.g., the storage device 130) of the medical system 100.

Further, the processing device 120 may determine the processed initial image based on the plurality of element values of the plurality of elements at the plurality of integer grids in the polar coordinate system. For example, the processing device 120 may determine the processed initial image by combining the plurality of element values of the plurality of elements at the plurality of integer grids in the polar coordinate system.

According to some embodiments of the present disclosure, for each projection angle of a plurality of projection angles of the medical device, the processing device 120 may transform an image (e.g., initial image) from a Cartesian coordinate system (e.g., the initial Cartesian coordinate system) corresponding to the projection angle (e.g., the initial projection angle) to the reference Cartesian coordinate system corresponding to the reference projection angle. Therefore, for each projection angle of the plurality of projection angles of the medical device, the interpolation operation in operation 720 and the coordinate transformation operation in operation 720 may be performed on images in the polar coordinate system and the reference Cartesian coordinate system, which may improve the computing speed of the coordinate transformation operation and the interpolation operation, and accordingly improve the efficiency of image reconstruction.

In some embodiments, the reference coordinate system may be omitted.

In some embodiments, the processing device 120 may determine a processed initial image by transforming the initial image from the initial coordinate system to the target coordinate system directly.

In some embodiments, the processing device 120 may obtain a plurality of element values of a plurality of elements at a plurality of grids in the target coordinate system based on a plurality of element values of a plurality of elements at a plurality of grids in the initial coordinate system. In some embodiments, the transformation relationship between the element value of the element in the initial coordinate system and the element value of the element in the target coordinate system may be determined by a transformation relation, and different projection angles may correspond to different transformation coefficients. In some embodiments, the transformation relationship between the element value of the element in the initial coordinate system and the element value of the element in the target coordinate system may be stored in a storage device (e.g., the storage device 130) of the medical system 100.

In some embodiments, the processing device 120 may determine the processed initial image based on the plurality of element values of the plurality of elements at the plurality of grids in the target coordinate system. For example, the processing device 120 may determine the processed initial image by combining the plurality of element values of the plurality of elements at the plurality of grids in the target coordinate system.

In some embodiments, the processing device 120 may also determine a processed initial image by transforming a plurality of element values of a plurality of elements in the initial coordinate system to a plurality of element values of a plurality of elements in the target coordinate system based on a coordinate mapping relationship, a fitting algorithm, an interpolation operation, or the like.

In some embodiments, the processing device 120 may determine the processed initial image based on the plurality of element values of the plurality of elements in the target coordinate system. For example, the processing device 120 may determine the processed initial image by combining the plurality of element values of the plurality of elements in the target coordinate system.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, operation 710 may be omitted. For example, the processing device 120 may generate a Cartesian coordinate system corresponding to each projection angle of a plurality of projection angles of the medical device. For each projection angle, the processing device 120 may determine a transformation relationship between a coordinate of an element in the Cartesian coordinate system corresponding to the projection angle and a coordinate of the element in the polar coordinate system.

FIG. 8 is a flowchart illustrating an exemplary process for determining a second difference image according to some embodiments of the present disclosure. In some embodiments, process 800 may be executed by the medical system 100. For example, the process 800 may be implemented as a set of instructions (e.g., an application) stored in a storage device (e.g., the storage device 130, the storage device 220, and/or the storage 390). In some embodiments, the processing device 120 (e.g., the processor 210 of the computing device 200, the CPU 340 of the mobile device 300, and/or one or more modules illustrated in FIG. 4) may execute the set of instructions and may accordingly be directed to perform the process 800. The operations of the illustrated process presented below are intended to be illustrative. In some embodiments, the process 800 may be accomplished with one or more additional operations not described and/or without one or more of the operations discussed. Additionally, the order of the operations of process 800 illustrated in FIG. 8 and described below is not intended to be limiting. In some embodiments, one or more operations of the process 800 may be performed to achieve at least part of operation 650 as described in connection with FIG. 6.

In 810, the processing device 120 (e.g., the determination module 430) may determine a third difference image by transforming a first difference image from a target coordinate system to a reference coordinate system.

Merely for illustration purposes and not limiting the scope of the present disclosure, the following descriptions are illustrated by taking the Cartesian coordinate system as the initial coordinate system and the polar coordinate system as the target coordinate system as an example.

In some embodiments, for each integer grid of a plurality of integer grids in the reference Cartesian coordinate system, the processing device 120 may determine a plurality of corresponding non-integer grids in the reference Cartesian coordinate system. The plurality of corresponding non-integer grids in the reference Cartesian coordinate system may correspond to a plurality of integer grids in the polar coordinate system. In some embodiments, a distance between the integer grid and each of the plurality of corresponding non-integer grids may be less than a distance threshold.

Merely by way of example, for an integer grid in the reference Cartesian coordinate system, the processing device 120 may determine eight corresponding non-integer grids in the reference Cartesian coordinate system according to Equations (15)-(22):

$${d}_{0} = {min}_{{x}_{i 0} , {y}_{j 0} , {z}_{k 0}} d ( [ {x}_{u} , {y}_{v} , {z}_{w} ] , ( {x}_{i 0} , {y}_{j 0} , {z}_{k 0} ) ) , {x}_{i 0} \leq {x}_{u} , {y}_{j 0} \leq {y}_{v} , {z}_{k 0} \leq {z}_{w} , \qquad ( 15 )$$

$${d}_{1} = {min}_{{x}_{i 1} , {y}_{j 1} , {z}_{k 1}} d ( [ {x}_{u} , {y}_{v} , {z}_{w} ] , ( {x}_{i 1} , {y}_{j 1} , {z}_{k 1} ) ) , {x}_{i 1} > {x}_{u} , {y}_{j 1} \leq {y}_{v} , {z}_{k 1} \leq {z}_{w} , \qquad ( 16 )$$

$${d}_{2} = {min}_{{x}_{i 2} , {y}_{j 2} , {z}_{k 2}} d ( [ {x}_{u} , {y}_{v} , {z}_{w} ] , ( {x}_{i 2} , {y}_{j 2} , {z}_{k 2} ) ) , {x}_{i 2} \leq {x}_{u} , {y}_{j 2} > {y}_{v} , {z}_{k 2} \leq {z}_{w} , \qquad ( 17 )$$

$${d}_{3} = {min}_{{x}_{i 3} , {y}_{j 3} , {z}_{k 3}} d ( [ {x}_{u} , {y}_{v} , {z}_{w} ] , ( {x}_{i 3} , {y}_{j 3} , {z}_{k 3} ) ) , {x}_{i 3} \leq {x}_{u} , {y}_{j 3} \leq {y}_{v} , {z}_{k 3} > {z}_{w} , \qquad ( 18 )$$

$${d}_{4} = {min}_{{x}_{i 4} , {y}_{j 4} , {z}_{k 4}} d ( [ {x}_{u} , {y}_{v} , {z}_{w} ] , ( {x}_{i 4} , {y}_{j 4} , {z}_{k 4} ) ) , {x}_{i 4} > {x}_{u} , {y}_{j 4} > {y}_{v} , {z}_{k 4} \leq {z}_{w} , \qquad ( 19 )$$

$${d}_{5} = {min}_{{x}_{i 5} , {y}_{j 5} , {z}_{k 5}} d ( [ {x}_{u} , {y}_{v} , {z}_{w} ] , ( {x}_{i 5} , {y}_{j 5} , {z}_{k 5} ) ) , {x}_{i 5} \leq {x}_{u} , {y}_{j 5} > {y}_{v} , {z}_{k 5} > {z}_{w} , \qquad ( 20 )$$

$${d}_{6} = {min}_{{x}_{i 6} , {y}_{j6} , {z}_{k 6}} d ( [ {x}_{u} , {y}_{v} , {z}_{w} ] , ( {x}_{i 6} , {y}_{j 6} , {z}_{k 6} ) ) , {x}_{i 6} > {x}_{u} , {y}_{j 6} \leq {y}_{v} , {z}_{k 6} > {z}_{w} , \qquad ( 21 )$$

$${d}_{7} = {min}_{{x}_{i 7} , {y}_{j7} , {z}_{k 7}} d ( [ {x}_{u} , {y}_{v} , {z}_{w} ] , ( {x}_{i 7} , {y}_{j 7} , {z}_{k 7} ) ) , {x}_{i 7} > {x}_{u} , {y}_{j 7} > {y}_{v} , {z}_{k 7} > {z}_{w} , \qquad ( 22 )$$

where [xᵤ,yᵥ,z_{w}] refers to an integer grid in the reference Cartesian coordinate system; (xᵢ₀,yⱼ₀,zₖ₀), (xᵢ₁,yⱼ₁,zₖ₁), (xᵢ₂,yⱼ₂,zₖ₂), (xᵢ₃,yⱼ₃,zₖ₃), (xᵢ₄,yⱼ₄,zₖ₄), (xᵢ₅,yⱼ₅,zₖ₅), (xᵢ₆,yⱼ₆,zₖ₆), and (xᵢ₇,yⱼ₇,zₖ₇) refer to a plurality of corresponding non-integer grids in the reference Cartesian coordinate system; and d₀, d₁, d₂, d₃, d₄, d₅, d₆, and d₇ refer to a distance between the integer grid [xᵤ,yᵥ,z_{w}] and each of the plurality of corresponding non-integer grids (xᵢ₀,yⱼ₀,zₖ₀), (xᵢ₁,yⱼ₁,zₖ₁), (xᵢ₃,yⱼ₃,zₖ₃), (xᵢ₄,yⱼ₄,zₖ₄), (xᵢ₅,yⱼ₅,zₖ₅), (xᵢ₆,yⱼ₆,zₖ₆), and (xᵢ₇,yⱼ₇,zₖ₇) in the reference Cartesian coordinate system.

The processing device 120 may determine a plurality of element values of a plurality of elements at the plurality of corresponding non-integer grids in the reference Cartesian coordinate system based on a plurality of element values of a plurality of elements at the plurality of integer grids in the polar coordinate system. For example, the processing device 120 may determine a coordinate of an element at a corresponding non-integer grid (xᵢ(lᵢ,γⱼ,φₖ), yⱼ(lᵢ,γⱼ,φₖ), zₖ(lᵢ,γⱼ,φₖ)) in the reference Cartesian coordinate system based on a coordinate of an element at an integer grid [lᵢ,γⱼ,φₖ] in the polar coordinate system according to Equations (23)-(25):

$${x}_{i} ( {l}_{i} , {γ}_{j} , {φ}_{k} ) = {l}_{i} * sin {γ}_{j} , \qquad ( 23 )$$

$${y}_{j} ( {l}_{i} , {γ}_{j} , {φ}_{k} ) = {l}_{i} * cos {γ}_{j} - {S}_{o} , \qquad ( 24 )$$

$${z}_{k} ( {l}_{i} , {γ}_{j} , {φ}_{k} ) = {l}_{i} * tan {φ}_{k} , \qquad ( 25 )$$

where Sₒ refers to a distance between a focal spot of a tube of the medical device and a rotation center of a gantry of the medical device; [lᵢ,γⱼ,φₖ] refers to a coordinate of an element at an integer grid in the polar coordinate system; and (xᵢ(lᵢ,γⱼ,φₖ), γⱼ(lᵢ,γⱼ,φₖ), zₖ(lᵢ,γⱼ,φₖ)) refers to a coordinate of an element at a corresponding non-integer grid in the reference Cartesian coordinate system. Accordingly, the element value of the element at the non-integer grid in the reference Cartesian coordinate system may be the same as the element value of the element at the integer grid in the polar coordinate system.

The processing device 102 may determine an element value of the integer grid in the reference Cartesian coordinate system by performing an interpolation operation on the plurality of element values of the plurality of elements at the plurality of corresponding non-integer grids in the reference Cartesian coordinate system. For example, the processing device 102 may determine the element value of the integer grid in the reference Cartesian coordinate system according to Equation (26):

$$U [ {x}_{u} , {y}_{v} , {z}_{w} ] = {\sum }_{m} \frac{{\sum }_{n} {d}_{n} - {d}_{m}}{{\sum }_{n} {d}_{n}} U ( {x}_{im} , {y}_{jm} , {z}_{km} ) , \qquad ( 26 )$$

where n refers to a number (or count) (e.g., 8) of the corresponding non-integer grids in the reference Cartesian coordinate system, and m is less than n.

Further, the processing device 120 may determine the third difference image based on a plurality of element values of a plurality of elements at the plurality of integer grids in the reference Cartesian coordinate system. For example, the processing device 120 may determine the third difference image by combining the plurality of element values of the plurality of elements at the plurality of integer grids in the reference Cartesian coordinate system.

In 820, the processing device 120 (e.g., the determination module 430) may determine a second difference image by transforming the third difference image from the reference coordinate system to an initial coordinate system.

Merely for illustration purposes and not limiting the scope of the present disclosure, the following descriptions are illustrated by taking the Cartesian coordinate system as the initial coordinate system and the polar coordinate system as the target coordinate system as an example.

In some embodiments, the processing device 120 may obtain a plurality of element values of a plurality of elements at a plurality of grids (e.g., integer grids) in the initial Cartesian coordinate system by performing an interpolation operation on a plurality of element values of a plurality of elements at a plurality of grids (e.g., integer grids) in the reference Cartesian coordinate system. For example, the processing device 120 may obtain a plurality of element values of a plurality of elements at a plurality of non-integer grids in the reference Cartesian coordinate system by performing the interpolation operation on the plurality of element values of the plurality of elements at the plurality of integer grids in the reference Cartesian coordinate system. The plurality of non-integer grids in the reference Cartesian coordinate system may correspond to the plurality of integer grids in the initial coordinate system. The processing device 120 may obtain the plurality of element values of the plurality of elements at the plurality of integer grids in the initial Cartesian coordinate system based on the plurality of element values of the plurality of elements at the plurality of non-integer grids in the reference Cartesian coordinate system.

Further, the processing device 120 may determine the second difference image based on the plurality of element values of the plurality of elements at the plurality of grids (e.g., integer grids) in the initial Cartesian coordinate system. For example, the processing device 120 may determine the second difference image by combining the plurality of element values of the plurality of elements at the plurality of integer grids in the initial Cartesian coordinate system.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

What is claimed is:

1. A method for image reconstruction, which is implemented on a computing device including at least one processor and at least one storage device, comprising:
obtaining original raw data acquired by a medical device;
obtaining an initial image; and
generating a target image based on the original raw data and the initial image according to an image reconstruction algorithm, including:
determining a processed initial image by transforming the initial image from an initial coordinate system to a target coordinate system, wherein a plurality of element values in the processed initial image are represented by a plurality of grids in the target coordinate system and the target coordinate system is determined based on a structure of a detector of the medical device; and
generating the target image based on the processed initial image.

2. The method of claim 1, wherein the generating the target image based on the processed initial image includes:
determining a first difference image based on the processed initial image;
determining a second difference image by transforming the first difference image from the target coordinate system to the initial coordinate system, wherein a plurality of element values in the second difference image are represented by a plurality of grids in the initial coordinate system; and
generating the target image based on the second difference image.

3. The method of claim 2, wherein the determining a first difference image based on the processed initial image includes:
determining first projection data by performing a forward projection operation on the processed initial image;
determining second projection data based on the first projection data and the original raw data; and
determining the first difference image by performing a back projection operation on the second projection data.

4. The method of claim 1, wherein the original raw data corresponds to a plurality of initial projection angles, and the determining a processed initial image by transforming the initial image from an initial coordinate system to a target coordinate system comprises:
determining a second processed initial image by transforming the initial image from the initial coordinate system to a reference coordinate system, wherein the reference coordinate system corresponds to a reference projection angle; and
determining the processed initial image by transforming the second processed initial image from the reference coordinate system to the target coordinate system.

5. The method of claim 2, wherein the determining a second difference image by transforming the first difference image from the target coordinate system to the initial coordinate system comprises:
determining a third difference image by transforming the first difference image from the target coordinate system to the reference coordinate system; and
determining the second difference image by transforming the third difference image from the reference coordinate system to the initial coordinate system.

6. The method of claim 5, wherein an origin of the reference coordinate system is located at a rotation center of a gantry of the medical device, and a first axis direction of the reference coordinate system is the same as a first axis direction of the target coordinate system.

7. The method of claim 1, wherein the target coordinate system at least includes a polar coordinate system.

8. The method of claim 1, wherein:
the detector of the medical device includes a plurality of detector units including at least one row of detector units arranged along a first direction and at least one column of detector units arranged along a second direction,
an origin of the target coordinate system is located at a focal spot of a tube of the medical device,
a first axis direction of the target coordinate system is along a line connecting the origin and a detector unit of the plurality of detector units,
a second axis direction of the target coordinate system is an angle direction between a line connecting the origin and a detector unit of the at least one row of detector units and the first axis direction, and
a third axis direction of the target coordinate system is an angle direction between a line connecting a detector unit of the plurality of detector units and the origin, and a plane formed by the first axis direction and the second axis direction.

9. The method of claim 8, wherein a size of each grid of the plurality of grids in the target coordinate system is related to a size of each detector unit of the plurality of detector units.

10. The method of claim 9, wherein:
a width of the each grid of the plurality of grids along the second axis direction of the target coordinate system is related to a width of a corresponding detector unit along the first direction, and
a height of the each grid of the plurality of grids along the third axis direction of the target coordinate system is related to a height of the corresponding detector unit along the second direction.

11. The method of claim 10, wherein a length of the each grid of the plurality of grids along the first axis direction of the target coordinate system is substantially the same as the width of the each grid of the plurality of grids along the second axis direction of the target coordinate system.

12. The method of claim 10, wherein the farther a grid is from the origin of the target coordinate system along the first axis direction, the smaller an angle between two sides of the grid along the second axis direction, or the smaller an angle between two sides of the grid along the third axis direction.

13. The method of claim 10, wherein a width of a detector unit along the first direction is an integer multiple of a width of a corresponding grid along the second axis direction of the target coordinate system, or a height of a detector unit along the second direction is an integer multiple of a height of a corresponding grid along the third axis direction of the target coordinate system.

14. The method of claim 9, wherein a projected edge of the plurality of grids on a detector plane is coincident with or parallel to an edge of the detector.

15. The method of claim 4, wherein the determining a second processed initial image by transforming the initial image from the initial coordinate system to a reference coordinate system comprises:
obtaining a plurality of element values of a plurality of elements at a plurality of grids in the reference coordinate system by performing an interpolation operation on a plurality of element values of a plurality of elements at a plurality of grids in the initial coordinate system; and
determining the second processed initial image based on the plurality of element values of the plurality of elements at the plurality of grids in the reference coordinate system.

16. The method of claim 4, wherein the determining the processed initial image by transforming the second processed initial image from the reference coordinate system to the target coordinate system comprises:
obtaining a plurality of element values of a plurality of elements at a plurality of non-integer grids in the reference coordinate system by performing an interpolation operation on a plurality of element values of a plurality of elements at a plurality of integer grids in the reference coordinate system, wherein the plurality of non-integer grids in the reference coordinate system correspond to a plurality of integer grids in the target coordinate system;
obtaining a plurality of element values of a plurality of elements at the plurality of integer grids in the target coordinate system based on the plurality of element values of the plurality of elements at the plurality of non-integer grids in the reference coordinate system; and
determining the processed initial image based on the plurality of element values of the plurality of elements at the plurality of integer grids in the target coordinate system.

17. The method of claim 5, wherein the determining a third difference image by transforming the first difference image from the target coordinate system to the reference coordinate system comprises:
for each integer grid of a plurality of integer grids in the reference coordinate system,
determining a plurality of corresponding non-integer grids in the reference coordinate system, wherein the plurality of corresponding non-integer grids in the reference coordinate system correspond to a plurality of integer grids in the target coordinate system;
determining a plurality of element values of a plurality of elements at the plurality of corresponding non-integer grids in the reference coordinate system based on a plurality of element values of a plurality of elements at the plurality of integer grids in the target coordinate system; and
determining an element value of the integer grid in the reference coordinate system by performing an interpolation operation on the plurality of element values of the plurality of elements at the plurality of corresponding non-integer grids in the reference coordinate system; and
determining the third difference image based on a plurality of element values of a plurality of elements at the plurality of integer grids in the reference coordinate system.

18. The method of claim 5, wherein the determining the second difference image by transforming the third difference image from the reference coordinate system to the initial coordinate system comprises:
obtaining a plurality of element values of a plurality of elements at the plurality of grids in the initial coordinate system by performing an interpolation operation on a plurality of element values of a plurality of elements at a plurality of grids in the reference coordinate system; and
determining the second difference image based on the plurality of element values of the plurality of elements at the plurality of grids in the initial coordinate system.

19. A system for image reconstruction, comprising:
at least one storage device including a set of instructions; and
at least one processor configured to communicate with the at least one storage device, wherein when executing the set of instructions, the at least one processor is configured to direct the system to perform operations including:
obtaining original raw data acquired by a medical device;
obtaining an initial image; and
generating a target image based on the original raw data and the initial image according to an image reconstruction algorithm, including:
determining a processed initial image by transforming the initial image from an initial coordinate system to a target coordinate system, wherein a plurality of element values in the processed initial image are represented by a plurality of grids in the target coordinate system and the target coordinate system is determined based on a structure of a detector of the medical device; and
generating the target image based on the processed initial image.

20. A non-transitory computer readable medium, comprising a set of instructions for image reconstruction, wherein when executed by at least one processor, the set of instructions direct the at least one processor to effectuate a method, the method comprising:
obtaining original raw data acquired by a medical device;
obtaining an initial image; and
generating a target image based on the original raw data and the initial image according to an image reconstruction algorithm, including:
determining a processed initial image by transforming the initial image from an initial coordinate system to a target coordinate system, wherein a plurality of element values in the processed initial image are represented by a plurality of grids in the target coordinate system and the target coordinate system is determined based on a structure of a detector of the medical device; and
generating the target image based on the processed initial image.
